(19) United States
(12) Patent Application Publication
(10) Pub. No.: US 2012/0020777 A1
(43) Pub. Date: Jan. 26, 2012

(54) DURABLE PUMPS FOR ABRASIVES

(75) Inventor: David M. Eslinger, Collinsville, OK (US)

(73) Assignee: SCHLUMBERGER TECHNOLOGY CORPORATION, SUGAR LAND, TX (US)

(21) Appl. No.: 13/174,343

(22) Filed: Jun. 30, 2011

Related U.S. Application Data
(60) Provisional application No. 61/360,431, filed on Jun. 30, 2010.
(60) Provisional application No. 61/365,695, filed on Jul. 19, 2010.
(60) Provisional application No. 61/360,031, filed on Jun. 30, 2010.

(51) Int. Cl. F04D 1/00; F04D 29/28; B23P 15/00; F04D 29/10

(52) U.S. Cl. 415/170.1; 416/174; 29/888.024

(57) ABSTRACT

Durable pumps for abrasives are provided. In one implementation, an example centrifugal pump or pump stage for subsurface operation has a thrust washer located inside the circumference of a close-fitting clearance seal between an impeller shroud and the diffuser. The relocation of the thrust washer allows the clearance seal to protect the thrust washer from abrasives while the thrust washer supports the impeller against the reaction forces of axial fluid flow. In one implementation, the radius or size of a thrust washer or other seal-like feature is reduced in order to increase exposure of the bottom impeller shroud to pressured fluid, thus balancing pressure at the top and bottom of the impeller to decrease friction between the impeller and the thrust washer. Reducing the radius of the thrust washer also reduces surface area of the washer subject to friction and reduces the moment arm of a braking torque on the rotating impeller, thereby reducing power loss in the pump.

### RELATED APPLICATIONS

This patent application claims the benefit of priority to U.S. Provisional Patent Application No. 61/360,031, Attorney Docket No. 89.0608, filed Jun. 30, 2010, and entitled: “Device and Means to Reduce Downthrust in a Multistage Centrifugal Pump,” and to U.S. Provisional Patent Application No. 61/365,695, Attorney Docket No. 89.0627, filed Jul. 19, 2010, and entitled: “Centrifugal Pump with Increased Abrasion Resistance,” both of which are incorporated herein by reference in their entirety.

### BACKGROUND

Oilfields sometimes use electric submersible pumps staged in series to pump downhole fluids. A number of centrifugal pump stages can be stacked together along their axial direction for ganged lift in a subsurface environment. Such subsurface multistage pumps are frequently employed to move fluids consisting of liquid hydrocarbon mixtures that may have some mixed and suspended earth solids. The fluid may also contain gaseous components and water. Particles and chunks of rock and sand are usually present to some degree. Such heterogeneous “liquid sandpaper” may result in cavitation and abrasion issues for pumps, especially if the solids cause deposits to build up against some surfaces of the pump or if the fluid itself has a slurry-like consistency. The viscosity and other flow characteristics of a particular liquid mixture may result in high velocity flow of the abrasive fluid around certain pump parts. Impellers used in downhole centrifugal pumps experience significant abrasion of the downthrust washers (hereinafter, “thrust washers”) when pumping fluids containing abrasives. Thus, the art of pump design aims to minimize abrasion and prolong the life of the pump. The particular composition and behavioral characteristics of the abrasive fluid to be pumped often allow particular pumps to be custom-designed and optimized for particular types of unrefined fluids.

### SUMMARY

Durable pumps for abrasives are provided. In one implementation, an example centrifugal pump or pump stage for subsurface operation has a thrust washer located inside the circumference of a close-fitting clearance seal between an impeller shroud and the diffuser. The relocation of the thrust washer allows the clearance seal to protect the thrust washer from abrasives while the thrust washer supports the impeller against the reaction forces of axial fluid flow. In one implementation, the radius or size of a thrust washer or other seal-like feature is reduced in order to increase exposure of the bottom impeller shroud to pressured fluid, thus balancing pressure at the top and bottom of the impeller to decrease friction between the impeller and the thrust washer. Reducing the radius of the thrust washer also reduces surface area of the washer subject to friction and reduces the moment arm of a braking torque on the rotating impeller, thereby reducing power loss in the pump.

This summary section is not intended to give a full description of durable pumps for abrasives. A detailed description with example implementations follows.

### BRIEF DESCRIPTION OF THE DRAWINGS

FIG. 1 is a diagram of an example stage of a multistage subsurface pump for pumping fluids containing abrasives.

FIG. 2 is a diagram of example inboard thrust washers for a subsurface pump for abrasives.

FIG. 3 is a diagram of example reduction in diameter of an inboard thrust washer.

FIG. 4 is a diagram of example reduction in diameter of a thrust washer to balance pressure areas to reduce friction.

FIG. 5 is a diagram of an example reduction in thrust washer diameter to decrease friction and reduce power loss.

FIG. 6 is a diagram of an example reduction in thrust washer diameter to decrease moment arm of a braking torque to reduce power loss.

FIG. 7 is a flow diagram of an example method of making an abrasion-resistant subsurface pump.

FIG. 8 is a flow diagram of an example method of increasing the durability and efficiency of an abrasion-resistant pump.

### DETAILED DESCRIPTION

Overview

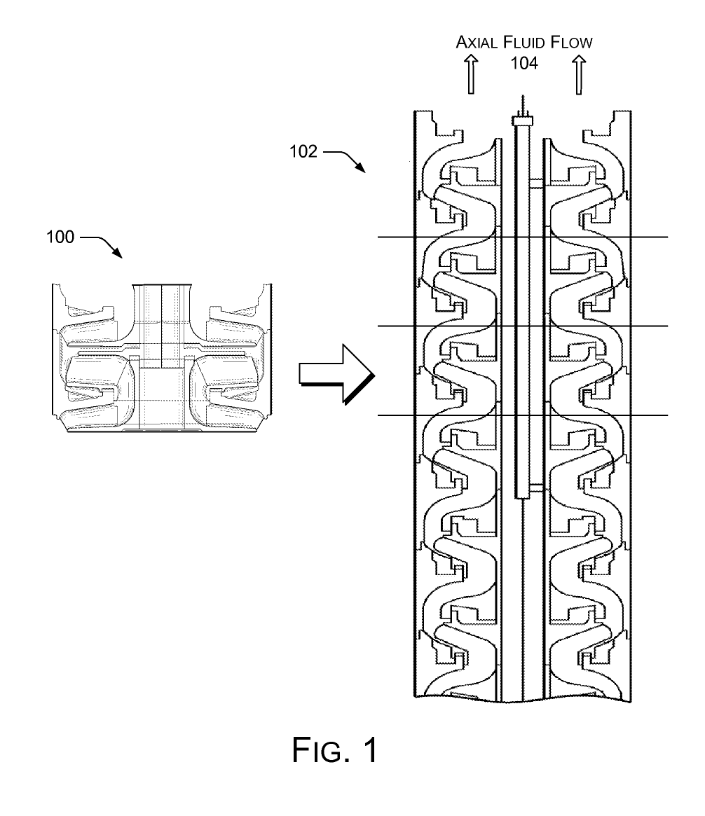

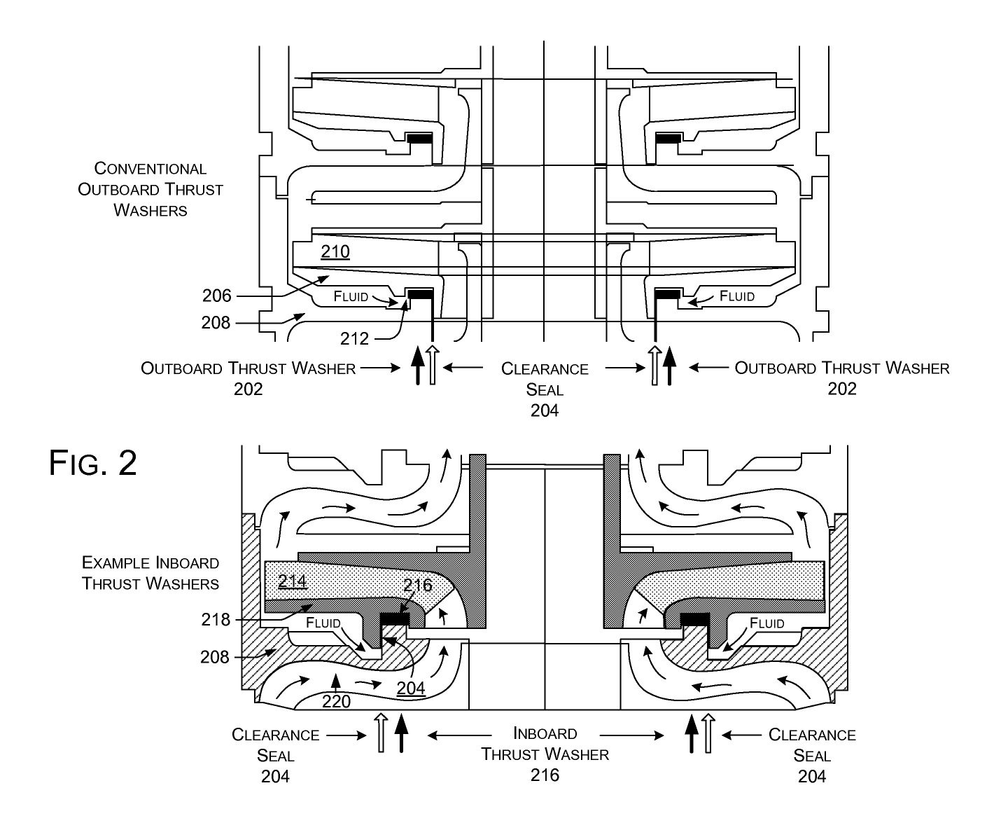

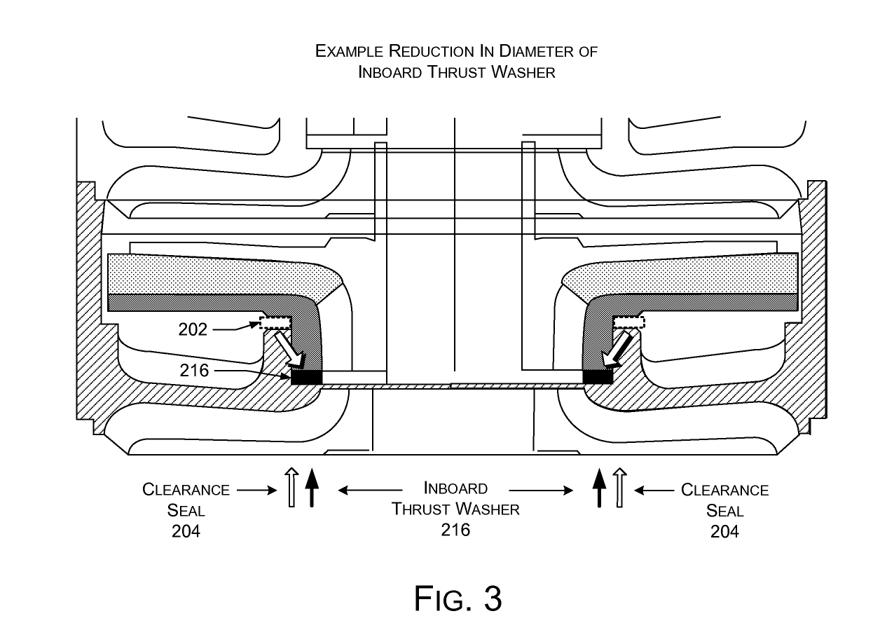

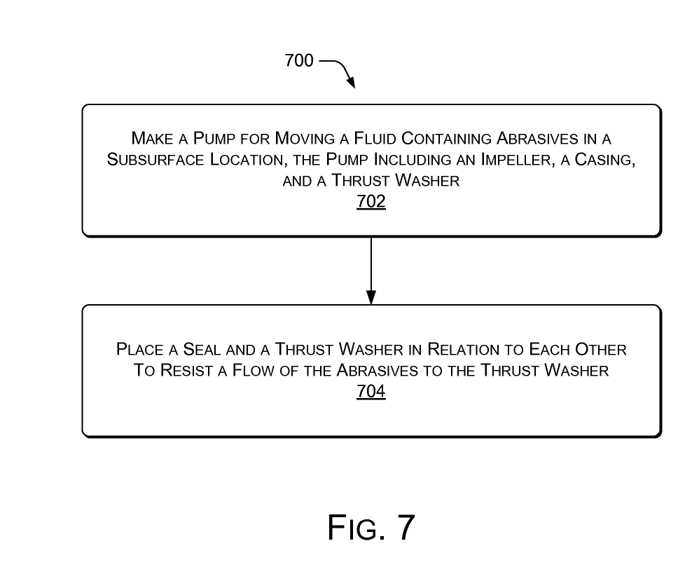

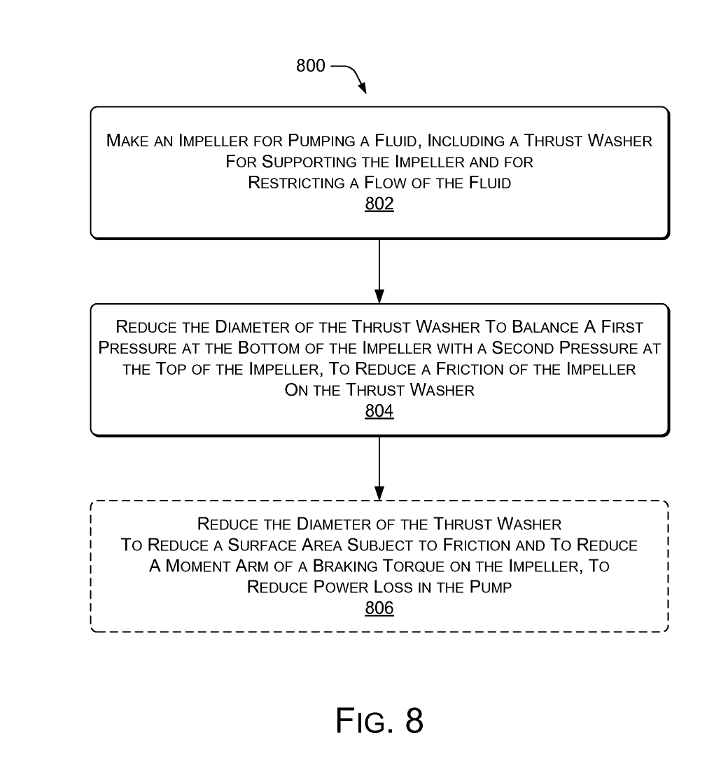

This disclosure describes durable pumps for abrasives. The described pumps provide higher wear and longer life than conventional designs, especially when pumping subsurface fluids containing some solids that tend to be abrasive when pumped, or when pumping slurries. FIG. 1 shows a cross-section of a centrifugal pump stage 100 of a multistage submersible pump stack 102. The multistage submersible pump stack 102 includes a number of the centrifugal pump stages 100 stacked together along their axial direction for ganged lift to generate axial fluid flow 104 in a subsurface environment. FIG. 2 shows example inboard thrust washers. FIGS. 3-6 show reduction of the diameter of example thrust washers, and associated benefits. FIGS. 7-8 show example methods of increasing the durability of pumps for abrasive fluids.

Example System Environment

Electric submersible pumps for abrasive fluids usually have at least one surface that is an impeller housing, or “shroud,” i.e., a solid part of the impeller assembly extending radially outward from a more central hub to strengthen and attach the impeller blades on one side, and also serving to screen or shield the impeller blades, at least in part, from the fluid on the other side of the shroud, since the shroud is solid. Impeller blades are typically attached to the shroud, and the shroud is typically attached to a hub that receives the rotational drive power of the pump, or, the shroud is an extension of the hub itself. Such a shroud may “underlie” the bottom sides of the impeller blades, or two shrouds may enclose both the top and bottom sides of the impeller blades in a “closed-impeller” or “enclosed” design in which only the radial ends of the impeller blades are open, as opposed to open-style impeller blades that are exposed to the fluid being pumped on all sides of the blades. Open-style impellers (without a shroud) are more susceptible to abrasive wear than a shrouded impeller, because high velocity fluid on the impeller blades is in close proximity to the casing walls (“diffuser” or housing), creating rotating vortices that accelerate wear when abrasives are present in the fluid.

Centrifugal pumps for moving fluids that may have abrasive properties typically incorporate a single shroud, located on the bottom of the impeller, or an enclosed design with both top and bottom shrouds. In an abrasive setting, the shroud(s) also provide additional structural support and reinforcement to protect against blade collapse or deformation. Such enclosed or semi-open impeller designs are well suited for handling solids in applications where the blades might encounter high impact loads from rocks and solids. A semi-open impeller also has an ability to pass solids in a manner similar to that of an open impeller type. With a single shroud the semi-open impeller is also relatively easy to manufacture.

High axial thrust is the primary drawback of semi-open and enclosed impeller designs: the rotating impeller creates a net fluid flow 104 along the axial direction but also creates large reaction forces, which thrust the shrouded impeller back in the opposite direction of the axial fluid flow. On a semi-open impeller, the entire backside surface of the shroud is subject to the full impeller discharge pressure. The front side of the shroud is at suction pressure at the eye of the impeller, where the fluid is inlet, and increases along the impeller radius due to centrifugal action.

The differential between the pressure profiles along the two sides of the shroud creates the axial thrust imbalance, referred to herein as downthrust. The downthrust can be countered with a thrust washer, which radially supports the backside of the shroud. There is also an efficiency loss due to disk friction caused by the impeller shroud turning in close proximity to the stationary casing wall. The downthrust forces are resisted by thrust washers on each stage for floater style pumps. Impellers of the mixed-flow type usually have balance rings which assist to keep these forces within acceptable limits. However, radial-flow impellers do not have such balance rings due to the need to minimize the stage axial length. The height of the wear rings, thrust washers, or other balance rings in the axial direction is of primary concern because this height directly affects the overall height of each pump stage, which is critical in many multistage pump designs. Therefore, radial impellers tend to have high thrust loads which lead to high mechanical friction power losses and a high thrust washer wear rate.

In centrifugal pumps, a portion of the fluid exiting from the rotating impeller characteristically leaks back to the pump suction by traveling through the gap between the impeller shroud and the casing. A semi-open impeller typically has wear rings or a front seal to control this leakage. In some pump stage designs, the outer edges of the thrust washer may perform this leakage-control role. Thus, the thrust washer may also aim to provide a fluid seal.

The thrust washers control recirculation through flow restriction, and may also be used in conjunction with impeller balance holes to control the axial thrust. However, the flow restriction created by tight clearances between rotating and stationary thrust washer faces causes very high local fluid velocities and thus a high wear rate. Conventional thrust washers, because they are subject to this high flow velocity, have a short life span in an abrasive environment, even when hard materials and treated surfaces are used.

The flow restriction at the thrust washer also causes solids to dam up at this location. Conventionally, as shown in the top of FIG. 2, an outboard thrust washer 202 is located radially outward from an impeller-to-diffuser shroud clearance seal 204 or other seal. Such a clearance seal 204 is typically a finely machined, close-fitting, close-running, metal-to-metal interface between the impeller shroud 206 and the diffuser (casing walls) 208 of the pump. The conventional wisdom of this arrangement is to support the impeller 210 against reactive forces from axial fluid flow 104, supporting the impeller 210 around a ring that has a substantial diameter under the impeller at some median radius of the impeller shroud 206. But a shortcoming of the outboard thrust washer 202 arrangement is that abrasive particles carried by fluid leakage from the impeller tip tend to accumulate at deposit location 212 in FIG. 2. This build-up of abrasive particles is due to the fact that the thrust washer axial clearance is larger than the radial clearance of front seal action and therefore the front seal acts as a particle dam. Accumulated abrasive particles rapidly wear the outboard thrust washer 202.

The thrust created by the impeller 210 in each stage of a submersible pump can be problematic in a variety of submersible pump types, including pumps with mixed flow stages and pumps with radial flow stages. In some floater style designs, for example, a significant portion of power loss in the pump is due to thrust friction occurring at an outer thrust washer due to relatively high friction-induced torque at this radially outlying position. If the outer thrust washer is removed from the floater style stage, however, the lack of any seal functionality increases leakage loss.

Example Pump and Impeller Design

As shown in the bottom part of FIG. 2, in one implementation of a pump stage 100, an example pump impeller 214 has an inboard thrust washer (pad, ring) 216 that is relocated inboard in relation to a seal 204 that defines a boundary of a fluid chamber of the diffuser (i.e., the stationary housing around the impeller). The relocation of the inboard thrust washer 216 “behind” the seal 204 protects the inboard thrust washer 216 from abrasive fluids being pumped and thus, from conventional abrasion and wear. The term “inboard,” as used herein, means “radially inward, toward, or closer to the axial center of rotation of the pump,” while “outboard” means “radially outward, away from, or further from the axial center of rotation of the pump.”

The aforementioned seal 204 may be a wear ring, or may be a finely machined, close-running interface between a rotating part of the impeller 214, usually an impeller shroud 218, and the stationary diffuser housing: i.e., an impeller shroud-to-diffuser clearance seal 204. With regard to abrasive fluid, since the protecting seal 204 is upstream from the inboard thrust washer 216 (with respect to fluid trying to return from the impeller 214 to the pump inlet 220) the amount of abrasive particles reaching the protected inboard thrust washer 216 is greatly reduced or eliminated. In conventional designs, an outboard thrust washer 202 may be in direct contact or even fully immersed in the fluid being pumped. The thrust washer 216 thus relocated and protected counteracts and supports against reactionary downthrust forces generated by the pumping impeller while providing higher wear and longer life than in conventional pumps used for pumping abrasive fluids in a multistage, subsurface environment.

In the same or another implementation, as shown in FIG. 3, the diameter (size, or “ring-size”) of a seal or a thrust washer at the bottom (i.e., back) of the impeller is strategically reduced in order to expose more surface area of the bottom impeller shroud to the pressured fluid being pumped. In some designs a seal, wear ring, or close-fitting interface between moving impeller and stationary diffuser forms the extent of the fluid space under the impeller, while in other designs the thrust washer 202 itself plays this role. The thrust washer 202 will be used as an example for the sake of description below, since it plays the additional role of a “wear ring” type seal in some pumps.

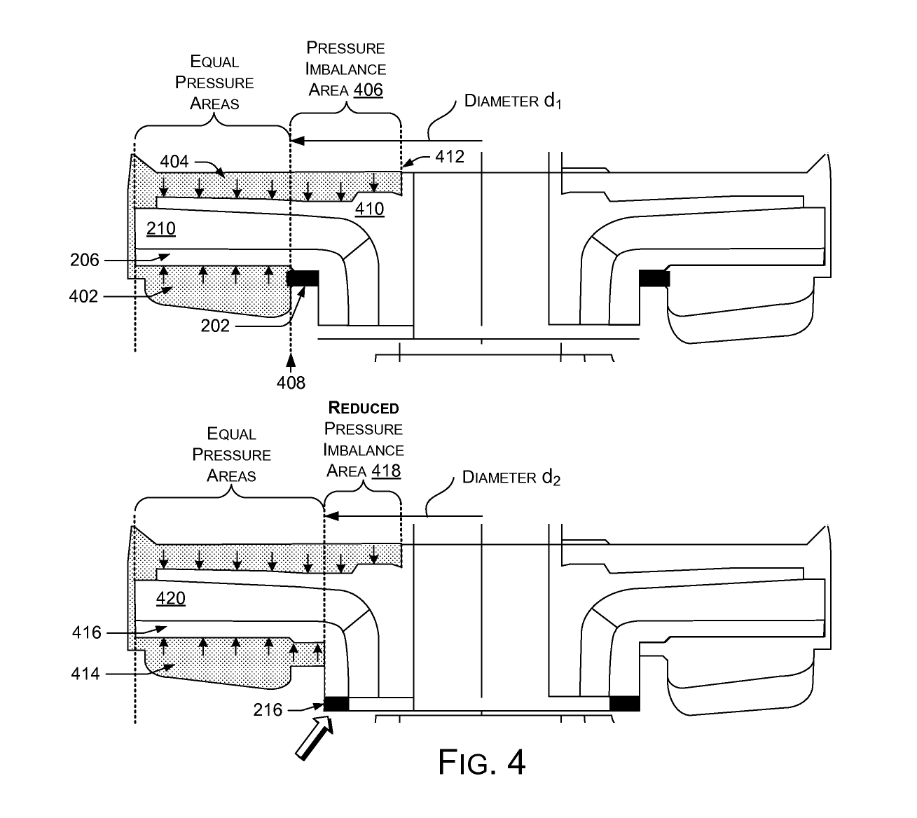

As shown in the top part of FIG. 4, a conventional thrust washer 202 defines the extent of a fluid chamber 402 at a bottom impeller shroud 206. The top of the impeller 210 has a fluid chamber 404 that exposes a greater amount of surface area at the top of the impeller 210 to pressured fluid, resulting in a pressure imbalance area 406, which thrusts the impeller 210 down into the thrust washer 202, where friction results in power loss. Downthrust forces tend to be high because pressure acting on the impeller bottom shroud surface 206 is sealed at the outside diameter 408 of the thrust washer 202, while pressure forces acting on the impeller top shroud surface 410 are sealed at the diffuser hub inside diameter 412.

In the bottom part of FIG. 4, reducing the diameter of the conventional thrust washer 202 to a smaller diameter thrust washer 216 when designing and manufacturing a pump, increases the extent of the bottom fluid chamber 414 and increases the amount of surface area of the bottom impeller shroud 416 that is exposed to the pressured fluid underneath. Referring to FIG. 4, reducing the diameter of the thrust washer 216 effectively reduces the pressure imbalance area 418, as given in Equation (1):

ΔA=(π/4)(d₁²−d₂²) (1)

where d₁ is the conventional outside diameter of the pressure imbalance area 406 and d₂ is the outside diameter of the reduced pressure imbalance area 418. Reducing the pressure imbalance area 418 in this manner increases the pressure at the bottom impeller shroud 416 thereby lifting the impeller 420 off the thrust washer 216 to some degree. The lift may not be a physical movement of the impeller 420 off the thrust washer 216, but may be a reduction in the net downthrust force acting on the impeller 420, or a reduction in the normal force Fₙ on the friction surface of the thrust washer 216, thus sparing the thrust washer 216. The friction on the surface of the thrust washer 216 may be approximated by the dry friction expression in Equation (2):

F_{f}≦μFₙ (2)

where F_{f} is the force of friction exerted by each surface on the other, and is parallel to the surface in a direction opposite to the net applied force; μ is the coefficient of friction, which is an empirical property of the materials used to make the thrust washer 216, and Fₙ is the normal force exerted by each surface on the other, directed perpendicular (normal) to the surface.

The diameter of the thrust washer 216 (or other seal) can thus be selectively reduced to strategically balance the exposed surface area and pressure at the bottom of the impeller 420 with the exposed surface area and pressure at the top of the impeller 420 to reduce friction and power loss. This balancing of pressures at the top and bottom of the impeller 420 through seal or washer size selection also provides additional benefits.

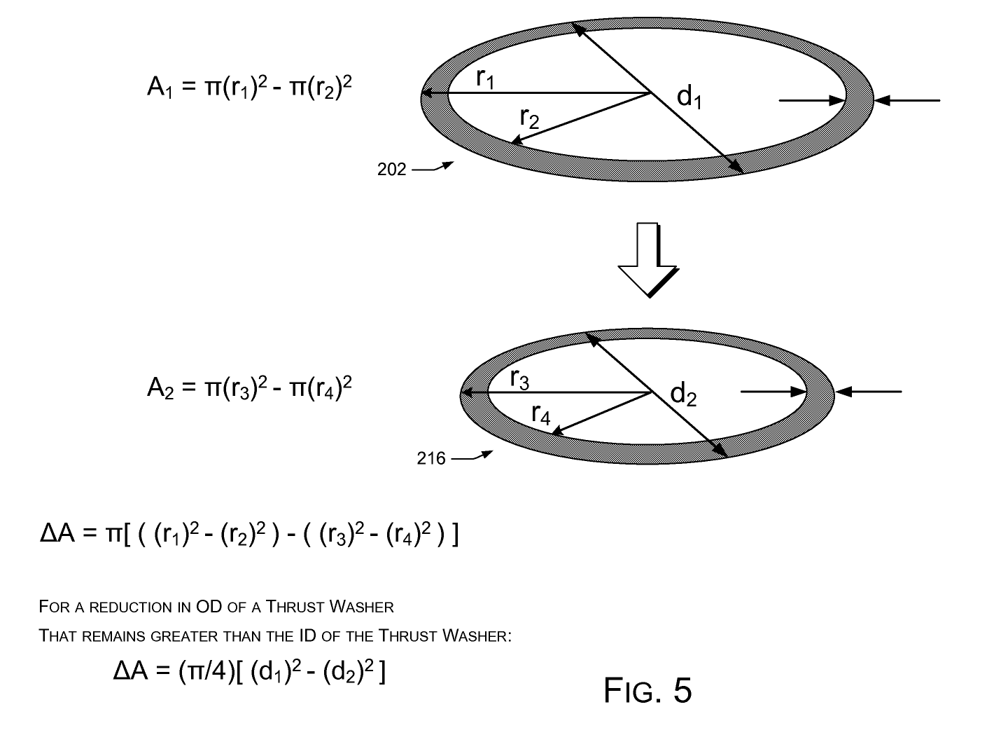

As shown in FIG. 5, in reducing the diameter of the conventional thrust washer 202, the reduced diameter of the smaller thrust washer 216 also reduces power loss because of less surface area for friction to occur on the smaller thrust washer 216. The reduction in surface area for friction to occur is given by Equation (3), using the radii shown in FIG. 5:

ΔA=π[(r₁²−r₂²)−(r₃²−r₄²)] (3)

For a reduction in the outside diameter of a conventional thrust washer 202 in which the new outside diameter of the smaller thrust washer 216 still remains larger than the initial inside diameter of the conventional thrust washer 202, the reduction in surface area for friction to occur may be given by Equation (4):

ΔA=(π/4)(d₁²−d₂²) (4)

where d₁ is the outside diameter of the conventional thrust washer 202 and d₂ is the outside diameter of the new, smaller thrust washer 216.

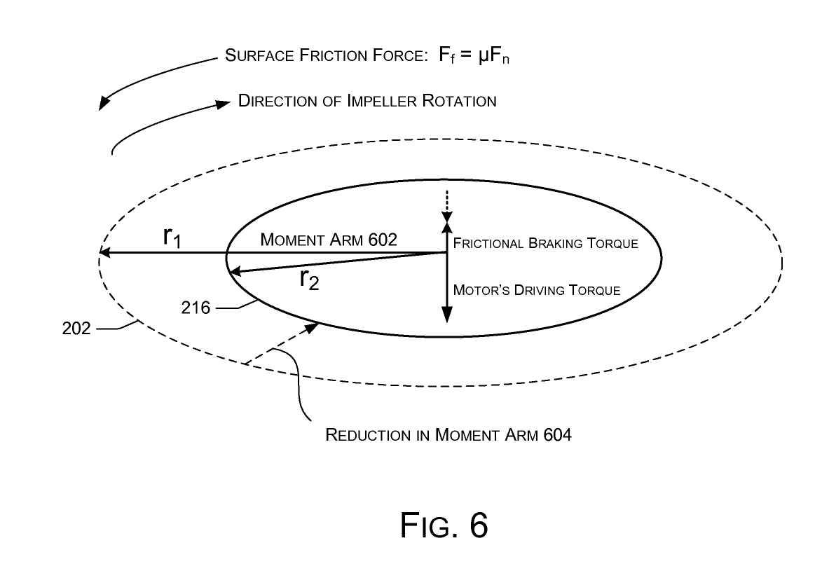

Further, as shown in FIG. 6, since the radius of the circle or ring defined by the conventional thrust washer 202 is reduced to that of the new smaller thrust washer 216, the moment arm 602 of the incidental braking force is reduced 604. The braking force is a high-friction-induced torque acting between the rotating shroud and the thrust washer 216, or between the stationary diffuser and the thrust washer 216, depending on set-up, as the thrust washer 216 undesirably acts like elements of a disk brake. The frictional torque is given by Equation (5):

τ=r×F (5)

where τ is the frictional braking torque, r is the moment arm 602 (or lever arm) and F is the friction force approximated by Equation (2) above. Thus, the reduction in frictional braking torque may be given by Equation (6), using the radii shown in FIG. 6:

Δτ=F(r₁−r₂) (6)

Relocating the seal or thrust washer may also increase efficiency of the pump and reduce wear by placing the thrust washer 216 or other seal where there is less agitation and turbulence in the abrasive fluid and/or where there is improved laminar flow away from closely interacting moving parts.

Example Methods

FIG. 7 is an example method 700 of making an abrasion-resistant subsurface pump. In the flow diagram, the operations are summarized in individual blocks.

At block 702, a pump for moving fluids containing abrasives in a subsurface location is made, including an impeller, a casing, and a thrust washer.

At block 704, a seal and a thrust washer are placed in relation to each other to resist a flow of the abrasives to the thrust washer.

FIG. 8 is an example method 800 of increasing the durability and efficiency of an abrasion-resistant pump. In the flow diagram, the operations are summarized in individual blocks.

At block 802, an impeller for pumping a fluid is made, including a thrust washer for supporting the impeller and for restricting a flow of the fluid.

At block 804, the diameter of the thrust washer is reduced to balance a first pressure at the bottom of the impeller with a second pressure at the top of the impeller, to reduce a friction of the impeller on the thrust washer.

At block 806, the diameter of the thrust washer is reduced to reduce a surface area subject to friction and to reduce a moment arm of a braking torque on the impeller, to reduce power loss in the pump.

### CONCLUSION

Although exemplary systems and methods have been described in language specific to structural features or techniques, the subject matter defined in the appended claims is not necessarily limited to the specific features or acts described. Rather, the specific features and acts are disclosed as example forms of implementing the claimed systems, methods, and structures.

1. A pump stage for a centrifugal pump for application in a subterranean hydrocarbon well, comprising:
a diffuser;
an impeller;
a thrust washer; and
a clearance seal that is located upstream of the thrust washer.

2. The pump stage of claim 1, wherein the clearance seal is formed between the impeller and the diffuser.

3. The pump stage of claim 1, wherein the thrust washer is located radially inward from the clearance seal with respect to a central axis of the pump stage.

4. The pump stage of claim 1, wherein the clearance seal resists a flow of a fluid from the impeller back to a fluid inlet, the clearance seal located between the fluid and the thrust washer.

5. The pump stage of claim 1, wherein the clearance seal comprises a close-running metal-to-metal interface between the impeller and the diffuser.

6. The pump stage of claim 5, wherein the close-running metal-to-metal interface comprises a flat interface of two surfaces running parallel to an axial direction of the pump stage, the flat interface interposed between a fluid and the thrust washer.

7. The pump stage of claim 1, wherein the fluid comprises an abrasive fluid and the clearance seal resists the flow of abrasive components in the abrasive fluid to the thrust washer.

8. The pump stage of claim 1, wherein a diameter of the thrust washer is reduced to locate the clearance seal upstream of the thrust washer; and
wherein a reduced diameter of the thrust washer increases a fluid pressure on a bottom side of the impeller to reduce a friction of the impeller on the thrust washer.

9. A submersible pump stage for a subsurface hydrocarbon well; comprising:
an impeller;
a diffuser; and
at least one thrust washer located inboard of at least one impeller-to-diffuser clearance seal thereby reducing a downthrust load acting on the impeller.

10. The submersible pump stage of claim 9, wherein said locating the thrust washer inboard of the impeller-to-diffuser clearance seal increases a first fluid pressure at a bottom of the impeller with respect to a second fluid pressure at the top of the impeller to reduce a friction of the impeller on the thrust washer.

11. The submersible pump stage of claim 9, wherein a reduced surface area of the thrust washer reduces a friction of the impeller on the thrust washer.

12. The submersible pump stage of claim 9, wherein a reduced diameter of the thrust washer reduces a moment arm of a braking torque acting between the impeller and the thrust washer, reducing a friction of the impeller on the thrust washer.

13. An impeller for a centrifugal pump for use in a subsurface hydrocarbon well, comprising:
an impeller including impeller blades attached to a shroud;
a thrust washer located radially inward from an impeller-to-diffuser clearance seal feature of the impeller.

14. The impeller of claim 13, wherein the centrifugal pump comprises a stage of a multistage subsurface pump for moving hydrocarbons containing abrasive solids.

15. The impeller of claim 13, wherein the impeller-to-diffuser clearance seal feature forms a close-running clearance seal with a stationary part of a diffuser.

16. The impeller of claim 15, wherein said thrust washer located radially inward from the impeller-to-diffuser clearance seal causes a bottom surface area of the shroud to be exposed to an increased fluid pressure to reduce a friction on the thrust washer.

17. The impeller of claim 13, wherein the thrust washer has a reduced diameter to locate the thrust washer inward of the impeller-to-diffuser clearance seal feature; and
wherein the reduced diameter of the thrust washer reduces a surface area of the thrust washer to decrease a friction on the thrust washer.

18. The impeller of claim 13, wherein the thrust washer has a reduced diameter to locate the thrust washer inward of the impeller-to-diffuser clearance seal feature; and
wherein the reduced diameter of the thrust washer reduces a moment arm of a braking torque acting on the thrust washer.

19. A method, comprising:
making a pump stage for a multi-stage submersible pump for a subsurface hydrocarbon well, the pump stage including an impeller, a diffuser, and a thrust washer; and
locating the thrust washer inboard of an impeller-to-diffuser clearance seal.

20. The method of claim 19, further comprising selecting a diameter for the thrust washer, wherein the selected diameter reduces a surface area of the thrust washer to decrease a friction on the thrust washer and reduces a moment arm of a braking torque acting on the thrust washer.
